(19) United States
(12) Patent Application Publication
(10) Pub. No.: US 2006/0110701 A1
(43) Pub. Date: May 25, 2006

(54) Dental kit

(75) Inventor: James L. Cwik, Willowbrook, IL (US)

Correspondence Address: MICHAEL BEST & FRIEDRICH LLP, Two Prudential Plaza, 180 North Stetson Avenue, Suite 2000, CHICAGO, IL, 60601, US

(73) Assignee: SUNSTAR AMERICAS, INC., Chicago, IL (US)

(21) Appl. No.: 10/993,084

(22) Filed: Nov. 19, 2004

(51) Int. Cl. A61C 3/00; A61C 17/00

(52) U.S. Cl. 433/31; 433/143; 433/29

(57) ABSTRACT

A dental kit including a first dental tool having a mirror and an illumination device, a second dental tool having a handle with a threadable or other suitable coupling and first and second tool heads selectively threadably or otherwise suitably connectable to the handle, and a container for holding the first and second dental tools. Also, a method including providing a dental kit having a first dental tool with a mirror and an illumination device and a second dental tool with a handle and first and second tool heads, switching the illumination device to an ON condition, selectively threading or otherwise coupling one of the tool heads to the handle, and using the first or second tool head as appropriate to probe, scrape, or clean the teeth while viewing the teeth with the first dental tool.

### FIELD OF THE INVENTION

The present invention generally relates to dentistry tools and, more specifically, to dental kits for consumer use.

### BACKGROUND OF THE INVENTION

Professional dentistry can be an expensive undertaking for a consumer even for simple dentistry check-ups and cleanings. Oftentimes in simple dentistry check-ups and cleanings, a dental professional will view, probe or clean a patient's teeth with professional dentistry viewing, probing and cleaning tools without performing any complicated procedures. The outcome of such simple check-ups may nevertheless be an expensive bill.

Some consumers may desire the capability of performing such simple check-up tasks and cleanings at home without going to the dentist and paying professional fees. Unfortunately, consumers may attempt to use household objects or other inappropriate tools to perform dental procedures. Performing dental procedures without proper dentistry tools can be ineffective, inefficient, or potentially dangerous.

For example, an individual may wish to view the interior of his or her mouth with a wall mirror or a hand held mirror. Using these types of mirrors is ineffective because of the many obstructed areas in the individual's mouth. Also, lighting the interior of the individual's mouth is difficult because light is often blocked by the individual's hands or portions of the individual's mouth such as teeth, tongue and cheek.

Accordingly, some consumers desire the capability to perform some simple dentistry procedures on themselves without excessive expenditure. The present invention provides a consumer dental kit that is convenient for the consumer to use and is economical. For example, this consumer dental kit can provide a first mirror usable in conjunction with a second mirror, such as, for example a wall mirror or a hand held mirror, so that the consumer can effectively view within his or her own mouth while he or she examines mouth, gum or teeth surfaces or while he or she probes or cleans selected portions thereof.

### SUMMARY OF THE INVENTION

A dental kit is provided having a first dental tool including a first handle, a mirror connected to the handle, and an illumination device operable to emit light toward the mirror such that the light reflects off of the mirror, a second dental tool including a second handle having a threadable coupling, a first tool head having a first threaded portion, and a second tool head having a second threaded portion, wherein the first threaded portion and the second threaded portion are complementary to the threadable coupling and one of the first threaded portion and the second threaded portion are engageable with the threadable coupling at a time to selectively threadably connect the one of the first tool head and the second tool head to the second handle, and a container for holding the first dental tool and the second dental tool.

Also provided is a dental kit having a first dental tool including a first handle, a mirror connected to the handle at an end of the handle, a light source, e.g., a LED, connected to the handle and operable to emit light toward the mirror such that the light reflects off of the mirror, and an actuator connected to the handle and electrically coupled to the light source, the actuator being moveable between an ON position and an OFF position to respectively turn the light source on and off, and a second dental tool including a second handle having a threadable coupling with internal threads, a scraper tool head having a first externally threaded portion, and a probe tool head having a second externally threaded portion, wherein the first externally threaded portion and the second externally threaded portion are complementary to the internal threads of the threadable coupling and one of the first externally threaded portion and the second externally threaded portion are engageable with the internal threads of the threadable coupling at a time to selectively threadably connect the one of the scraper tool head and the probe tool head to the second handle.

In addition, a method is provided for viewing, scraping and probing a user's teeth, the method including providing a dental kit including a first dental tool and a second dental tool, the first dental tool including a handle, a mirror connected to the handle and an illumination device operable to emit light toward the mirror such that light reflects off of the mirror, the second dental tool including a handle having a threadable coupling, a first tool head having a first threaded portion complementary to the threadable coupling, and a second tool head having a second threaded portion complementary to the threadable coupling. The method also includes switching the illumination device to an ON condition causing the illumination device to emit light toward the mirror, selectively threading one of the first tool head and the second tool head to the handle of the second dental tool by threadably engaging the one of the first threaded portion and the second threaded portion to the threadable coupling, and using the first tool head or the second tool head as appropriate to probe or scrape the teeth while viewing the teeth with the first dental tool.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

FIG. 1 is a partially exploded perspective view of a dental kit embodying aspects of the invention.

FIG. 2 is a top view of a mirror dental tool of the dental kit shown in FIG. 1, shown with a portion cutaway to expose a power source (exemplified here as a battery) of the mirror dental tool.

FIG. 3 is an enlarged cross-sectional view of a portion of a dental tool of the dental kit shown in FIG. 1.

Before at least one embodiment of the invention is explained in detail, it is to be understood that the invention is not limited in its application to the details of the construction and arrangements of the components set forth in the following description or illustrated in the drawings. The invention includes other embodiments and can be practiced or carried out in various different ways. Also, it is understood that the phraseology and terminology used herein is for the purpose of description and should not be regarded as limiting. The use of “including,” “comprising,” or “having” and variations thereof is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION

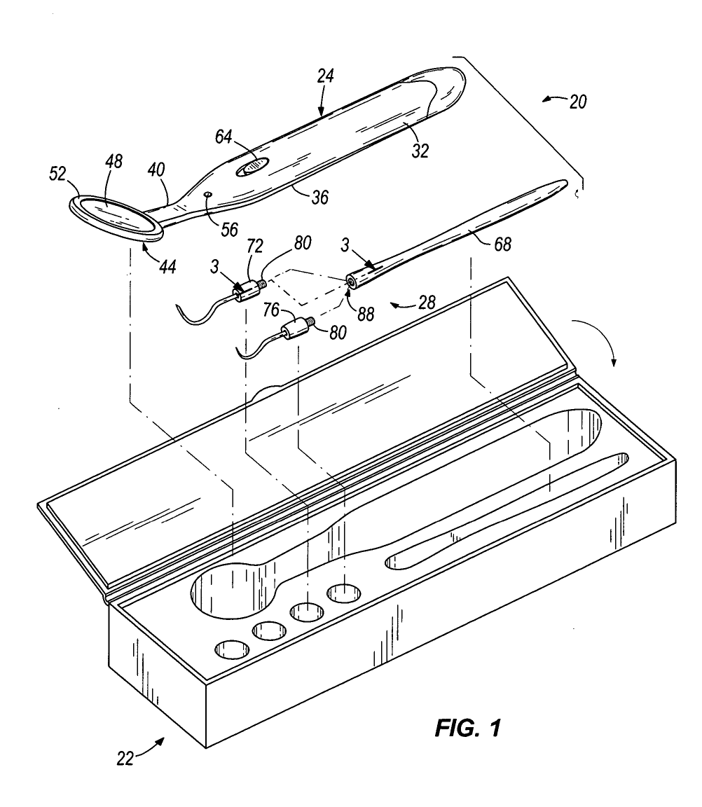

Referring to FIG. 1, dental kit 20 is illustrated and includes container 22 of any desired shape or construction, mirror dental tool 24 and a multi-headed dental tool 28. Dental kit 20 is typically used by a consumer; however, dental kit 20 can be used by a dentist or other dental professional, such as a dental technician, a dental hygienist, etc. Mirror dental tool 24 is usable in combination with a second mirror (not shown), such as, for example a wall mirror or hand held mirror, by an individual to view the interior of his or her mouth, while multi-headed dental tool 28 is usable by an individual to probe, scrape, or clean teeth within his or her mouth.

With reference to FIG. 1, container 22 is operable to hold mirror dental tool 24 and multi-head dental tool 28 therein. The container 22 is provided with recessed compartments configured to receive the items included in the kit 20. As can be seen from FIG. 1, a separate compartment is provided for the handle 68 of the dental tool 28. Likewise, separate compartments are provided for the heads 72, 76 of the dental tool 28. Thus, container 22 provides protection to and a convenient packaging for mirror dental tool 24 and multi-head dental tool 28. Dental kit 20 can be sold or provided to consumers with mirror dental tool 24 and multi-head dental tool 28 within container 22. After the consumer obtains dental kit 20, container 22 can be discarded or can be kept to store mirror dental tool 24 and multi-head dental tool 28. The dental kit 20 can also be packaged on a card to which a heat-sealed blister is attached enclosing the kit 20. This blister package may be designed to be hung on racks at the point of sale.

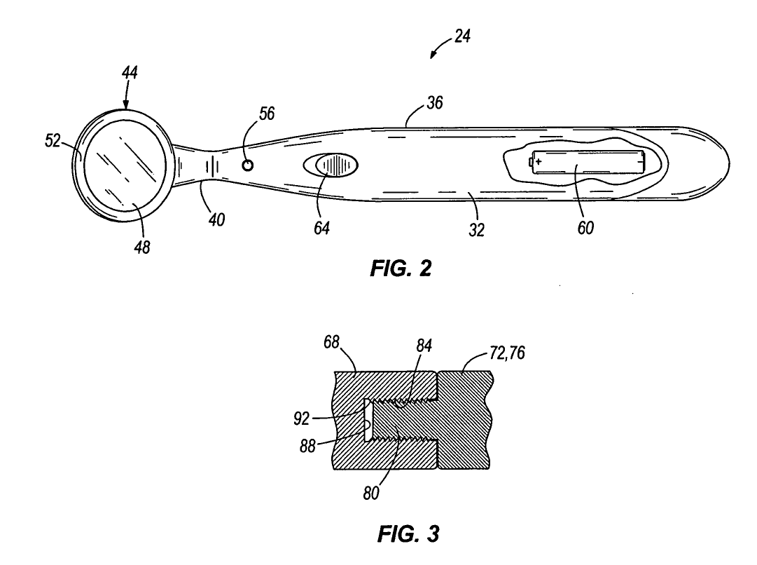

With reference to FIGS. 1 and 2, mirror dental tool 24 includes handle 32 having wide portion 36 graspable by a user and narrow portion 40 extending from wide portion 36. Handle 32 can be made of a variety of materials and be within the spirit and scope of the present invention. In some constructions, handle 32 is made of plastic. In other constructions, handle 32 is made of metal. In yet other constructions, handle 32 is made of a plurality of materials. For example, a portion of wide portion 36 graspable by a user could be covered with a resilient rubber material and the underlying material could be plastic, metal, or some other material.

Mirror dental tool 24 also includes mirror portion 44 connected to the end of narrow portion 40 and includes mirror 48 and rim 52 surrounding an edge of mirror 48 to retain mirror 48 within mirror portion 44. Alternatively, the mirror can be affixed to the dental tool 24 by gluing or other suitable means without using the rim 52. In the illustrated construction, mirror 48 is made of a reflective material having properties that inhibit fogging or steaming of the surface of mirror 48. Mirror dental tool 24 further includes illumination device 56, power source or battery 60, and actuator or switch 64 that is electrically connected, in a conventional manner, to illumination device 56 and battery 60 to selectively provide and interrupt power between illumination device 56 and battery 60. In the illustrated construction, illumination device 56 is a white light emitting diode (“LED”), however, LED 56 can be other colored LEDs and other types of illumination devices and still be within the spirit and scope of the present invention. Illumination device 56 is connected to handle 32 in a position between switch 64 and mirror portion 44 and is oriented in a manner to emit light toward mirror 48 such that light reflects off of mirror 48 to illuminate the interior of an individual's mouth when mirror dental tool 24 is in use. It should be understood that LED 56 can be connected to handle 32 in other positions and have other orientations relative to mirror portion 44 and still be within the spirit and scope of the present invention as long as LED 56 is operable to emit light toward mirror 48.

In the illustrated construction, power source 60 is a conventional AA or AAA dry cell. Power source 60 can be a large variety of power providing devices, such as, for example a circular disc dry cell (frequently used in wristwatches). In the illustrated construction, mirror dental tool 24 is intended to be discarded after power source 60 is sufficiently drained, no longer providing sufficient power to illuminate LED 56. In such a construction, power source 60 is permanently secured within mirror dental tool 24 and is not replaceable. A user can discard mirror dental tool 24 after power source 60 is sufficiently drained. In some constructions, mirror dental tool 24 is re-usable and power source 60 is replaceable with a new power source. In such a construction, a portion of handle 32 is removable to expose power source 60 located within handle 32. Power source 60 is removed and a new power source is positioned within handle 32. Power source replacement can be performed any number of times. In both the replaceable and non-replaceable power source versions, a resistor can be added to the electrical circuit to lengthen the life of the battery or other power source.

With continued reference to FIGS. 1 and 2, switch 64 is moveable between an ON-position, in which power is allowed to flow from battery 60 to LED 56, and an OFF-position, in which power is interrupted and prevented from flowing from battery 60 to LED 56. When in the ON-position, LED 56 illuminates to emit light toward mirror 48, while when in the OFF-position, LED 56 is not illuminated. In the illustrated construction, switch 64 is slideable between the ON-position and the OFF-position. In some constructions, switch 64 can be a depressible type switch. In other constructions, switch 64 can be a rotatable type switch.

With reference to FIGS. 1 and 3, multi-head dental tool 28 includes handle 68 and a plurality of tool heads selectively connectable to handle 68. Handle 68 can be made of similar materials as handle 32 and can include all of the alternatives of handle 32 listed above. Accordingly, for the sake of brevity, materials and alternatives of handle 68 will not be discussed herein. In the illustrated construction, the plurality of tool heads includes scraper tool head 72 and probe tool head 76. Scraper tool head 72 is used to scrape and clean the user's teeth and probe tool head 76 is used to probe and clean between the user's teeth. Each of scraper tool head 72 and probe tool head 76 includes threaded portion 80 having external threads 84 thereon for inserting into threadable coupling 88 defined in handle 68 and engaging complementary internal threads 92 on the threadable coupling 88. Engagement between complementary external threads 84 of either scraper tool head 72 or probe tool head 76 and internal threads 92 selectively threadably connects either scraper tool head 72 or probe tool head 76 to handle 68. The male and female threaded parts can be reversed. Scraper tool head 72 and probe tool head 76 are selectively threadably connectable to handle 68 one at a time.

It should be understood that multi-head dental tool 28 can include other types of tool heads and still be within the spirit and scope of the present invention. In such cases, all of the tool heads are selectively connectable to handle 68 one at a time. Also, the tool heads may be connected to the handle by means other than threading, e.g., by friction fit, snap fit, or bayonet fit.

Dental kit 20 is manufactured in such a manner to provide the consumer with an attractive and economical option for performing simple dentistry procedures within their own mouth. Dental kit 20 is so economical, an individual may discard the kit 20 when the kit becomes worn-out, inoperative, or for other reasons and purchase a new dental kit 20 without excessive expenditures. Also, dental kit 20 may provide an alternative to purchasing professional dental tools or spending money on dentistry check-ups that may include procedures performable by the consumer.

In addition, dental kit 20 provides the consumer with dental procedures that promote good oral hygiene. For example, frequent viewing, probing, scraping and cleaning of an individual's teeth may improve the oral hygiene of the individual and help prevent tooth decay or other oral complications.

Further, dental kit 20 includes single tools that perform multiple dental procedures and, therefore, the kit 20 is compact and less expensive than obtaining a plurality of tools that only perform a single procedure. For example, dentists include a single tool for viewing, a single tool for lighting, a single tool for probing, and a single tool for scraping and cleaning, while dental kit 20 includes a single tool for viewing and lighting and a single tool with multiple heads for probing, scraping, and cleaning.

The constructions and embodiments described above and illustrated in the drawings are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

1. A dental kit comprising:
a first dental tool including
a first handle,
a mirror connected to the handle, and
an illumination device operable to emit light toward the mirror such that the light reflects off of the mirror;
a second dental tool including
a second handle having a threadable coupling,
a first tool head having a first threaded portion, and
a second tool head having a second threaded portion;
wherein the first threaded portion and the second threaded portion are complementary to the threadable coupling and one of the first threaded portion and the second threaded portion is engageable with the threadable coupling at a time to selectively threadably connect the one of the first tool head and the second tool head to the second handle; and
a container for holding the first dental tool and the second dental tool.

2. The dental kit of claim 1, wherein the threadable coupling includes internal threads and the first threaded portion and the second threaded portion include external threads.

3. The dental kit of claim 1, wherein the illumination device is a white LED.

4. The dental kit of claim 1, wherein the first dental tool further includes an actuator electrically coupled to the illumination device and is moveable between an ON position and an OFF position to respectively turn the illumination device on and off.

5. The dental kit of claim 4, wherein the actuator is from the group consisting of slideable, depressible, or rotatable actuators moving between the ON and OFF positions.

6. The dental kit of claim 4, wherein the illumination device and the actuator are connected to the handle, the illumination device being positioned between the mirror and the actuator.

7. The dental kit of claim 1, wherein the first tool head is a scraper and the second tool head is a probe.

8. A dental kit comprising:
a first dental tool including
a first handle,
a mirror connected to the handle, and
an illumination device operable to emit light toward the mirror such that the light reflects off of the mirror;
a second dental tool including
a second handle having a coupling,
a first tool head having a first portion, and
a second tool head having a second portion;
wherein the first portion and the second portion are complementary to the coupling and one of the first portion and the second portion is engageable with the coupling at a time to selectively connect the one of the first tool head and the second tool head to the second handle; and
a container for holding the first dental tool and the second dental tool.

9. The dental kit of claim 8 wherein the coupling for the handle and the tool heads is a threaded fit, a friction fit, snap fit or bayonet fit.

10. The dental kit of claim 1 wherein the kit is in a blister package.

11. The dental kit of claim 8 wherein the kit is in a blister package.

12. A dental kit comprising:
a first dental tool including
a first handle,
a mirror connected to the handle at an end of the handle,
an LED connected to the handle and operable to emit light toward the mirror such that the light reflects off of the mirror, and
an actuator connected to the handle and electrically coupled to the LED, the actuator being moveable between an ON position and an OFF position to respectively turn the LED on and off; and
a second dental tool including
a second handle having a threadable coupling with internal threads,
a scraper tool head having a first externally threaded portion, and
a probe tool head having a second externally threaded portion;
wherein the first externally threaded portion and the second externally threaded portion are complementary to the internal threads of the threadable coupling and one of the first externally threaded portion and the second externally threaded portion are engageable with the internal threads of the threadable coupling at a time to selectively threadably connect the one of the scraper tool head and the probe tool head to the second handle.

13. The dental kit of claim 12, wherein the LED is positioned between the actuator and the mirror.

14. The dental kit of claim 12, wherein the actuator is slideable, depressible, or rotatable between the ON and OFF positions.

15. The dental kit of claim 12, further comprising a container for holding the first dental tool and the second dental tool.

16. A method for viewing, scraping, cleaning and probing a user's teeth, the method comprising:
providing a dental kit including a first dental tool and a second dental tool, the first dental tool including a handle, a mirror connected to the handle and an illumination device operable to emit light toward the mirror such that light reflects off of the mirror, the second dental tool including a handle having a threadable coupling, a first tool head having a first threaded portion complementary to the threadable coupling, and a second tool head having a second threaded portion complementary to the threadable coupling;
switching the illumination device to an ON condition causing the illumination device to emit light toward the mirror;
selectively threading one of the first tool head and the second tool head to the handle of the second dental tool by threadably engaging the one of the first threaded portion and the second threaded portion to the threadable coupling; and
using the first tool head or the second tool head as appropriate to probe or scrape the teeth while viewing the teeth with the first dental tool.

17. The method of claim 16, wherein the illumination device is an LED.

18. The method of claim 17, wherein the first tool head is a scraper and the second tool head is a probe.

19. The method of claim 16, wherein switching the illumination device includes sliding, depressing or rotating an actuator of the first dental tool to an ON position to switch the illumination device to the ON condition.

20. The method of claim 16, wherein providing a dental kit includes providing a dental kit including a container for holding the first dental tool and the second dental tool.
